(19) United States
(12) Patent Application Publication
(10) Pub. No.: US 2013/0304568 A1
(43) Pub. Date: Nov. 14, 2013

(54) METHOD AND SYSTEM FOR CONNECTING USERS TO SOCIAL MEDIA THROUGH RICH MEDIA INTERACTIONS

(71) Applicant: Dressler LLC, New York, NY (US)

(72) Inventors: Nathan Hunt, New York, NY (US); Vail Gold, New York, NY (US); Jan Buchholz, New York, NY (US)

(73) Assignee: Dressier LLC, New York, NY (US)

(21) Appl. No.: 13/891,783

(22) Filed: May 10, 2013

Related U.S. Application Data
(60) Provisional application No. 61/645,095, filed on May 10, 2012.

(51) Int. Cl. G06Q 30/02

(52) U.S. Cl. CPC G06Q 30/0245
USPC 705/14.44

(57) ABSTRACT

A method and system for online advertisements that encourages users to express purchase preference or brand interest on their social media networks through rich media interactions. The system includes a processor, a network interface configured to connect to a network and a machine readable storage medium configured to store program instructions which, when executed, cause the processor to perform a method for encouraging users to express purchase preference or brand interest on their social media networks through rich media interactions. An interactive display is arranged on a screen comprising a prompt and a plurality of selectable multimedia elements. A user responds to the prompt by designating a multimedia to enable transmission of preference data responsive to the prompt. The preference data associated with the designated multimedia element to a server connected to the network.

### REFERENCE TO RELATED APPLICATIONS

This application is a U.S. non-provisional utility patent application claiming priority to U.S. Provisional Patent Application Ser. No. 61/645,095 filed May 10, 2012, which is hereby incorporated by reference as if fully disclosed herein.

### FIELD OF THE DISCLOSURE

The present disclosure relates to on-line advertising, namely, the use of rich media interactions to determine purchasing preferences and opinions on an advertiser's products and then share those preferences through social media networks with a link to encourage further sharing.

### BACKGROUND OF THE INVENTION

On-line advertising has become an increasingly important are for marketing new or existing products. Typically, website advertisements (i.e., banner ads) have been used for one of two purposes. First, an advertisement may be used as a branding advertisement, similar to a billboard or print advertisement, where the user browsing the website is shown a graphical advertisement for a branded product. This form of on-line advertising relies on traditional brand association. Second, an advertisement may be used for click-through marketing. A click-through advertisement is one where the user is invited to click on an advertisement to connect to a different website that provides the user with additional information on the product or brand advertised or with the opportunity to purchase the branded product. While both methods may feature a variety of modes of interaction, their intention is either to drive purchase through positive association with the brand or by driving the user to a website where the product may be purchased.

### SUMMARY OF THE INVENTION

A system and method is disclosed that includes an interactive, digital display, comprising one or more multimedia elements, at least one of which a user may designate or otherwise alter in some way. After the designation, the system processes user preference data associated with the multimedia elements, based on which of the multimedia elements were designated and which were not. The system transmits that data to another party, preferably a communication platform, such as a social media network or an email provider.

Methods for use of the invention may include advertisement campaigns, social media campaigns, marketing campaigns, public relations campaigns or any other effort to deliver any information to any number of people or groups of people. The invention may also be used for any type of crowd-sourced data processing or collection, including polling, mathematical problems, pattern matching, data association, situational decisions or any other task that the invention can convey through its medium.

### BRIEF DESCRIPTION OF THE DRAWINGS

Embodiments will be described with reference to the following drawing figures, in which like numerals represent like items throughout the figures, and in which:

FIG. 1A-B are block diagrams of an interactive display with a drop zone;

FIG. 2 is a block diagram of an interactive display without a drop zone;

FIG. 3 is a block diagram of an interactive display with a drop zone and including additional multimedia elements;

FIG. 4 is a block diagram of a communication device; and,

FIG. 5 is a flow diagram of an exemplary method.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout the specification may, but do not necessarily, refer to the same embodiment.

Furthermore, the described features, advantages and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

Social media websites have become a commonplace feature in user's on-line interactivity. Websites, such as Facebook®, Twitter®, and Pintrest®, connect users together in in a social network that allows for direct communication of preferences and interests, and allows for the growth of online communities surrounding those interests. Brand owners are interested in promoting their brands through social media. Word of mouth is a much stronger driver of purchase intent than conventional advertising through non-interactive advertisements or click-through advertisements. Therefore, new systems and methods are required to encourage the self-expression of users' purchasing choices and opinions in the promotion of brands through social media.

A system and method is disclosed that includes an interactive, digital display comprising one or more multimedia elements, at least one of which a user may designate or otherwise alter in some way. After the designation, the system processes the multimedia elements in such a way to allow user preference data to be synthesized, based on which of the multimedia elements were designated and which were not, and transmit that data to another party, preferably a communication platform, such as a social media network or an email provider.

The system may exist within any digital medium, including webpages, smartphone applications, videos, documents, or any other digital interface. It may be hosted in any number of locations and serve any destination, local or remote, from any location where it is hosted. It may be a stand-alone object or region of any size and form factor, especially conforming to popular banner advertisement dimensions, such as the 300×250 pixel format. It may be visible upon first loading of the digital medium, or it may appear at any time thereafter based on a timer or specific user action. It may also initially comprise a user interface element and, upon user interaction with the element, transform other content within the digital medium into an interactive display characteristic of the invention. Any of the elements of the display may change state, appearance, shape, form or any other property at any time.

The system will provide an interactive display of a plurality of multimedia elements. The interactive display will allow users to move, select, alter, manipulate, or otherwise designate any number of the multimedia elements. This interaction may comprise dragging and dropping, clicking, hovering, zooming, drawing, cropping, organizing, orienting, otherwise altering the visual state of the display through user-generated input from any device or no interaction at all. The interactive display may have any styling, including backgrounds and borders of any design, pattern, color or lack thereof. Not all of the multimedia elements of the display may be interactive in every embodiment.

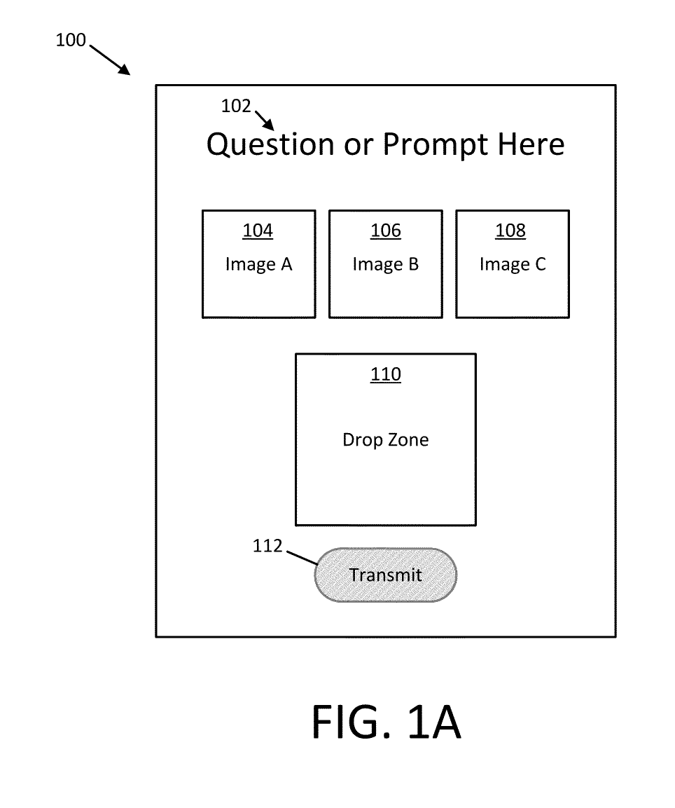

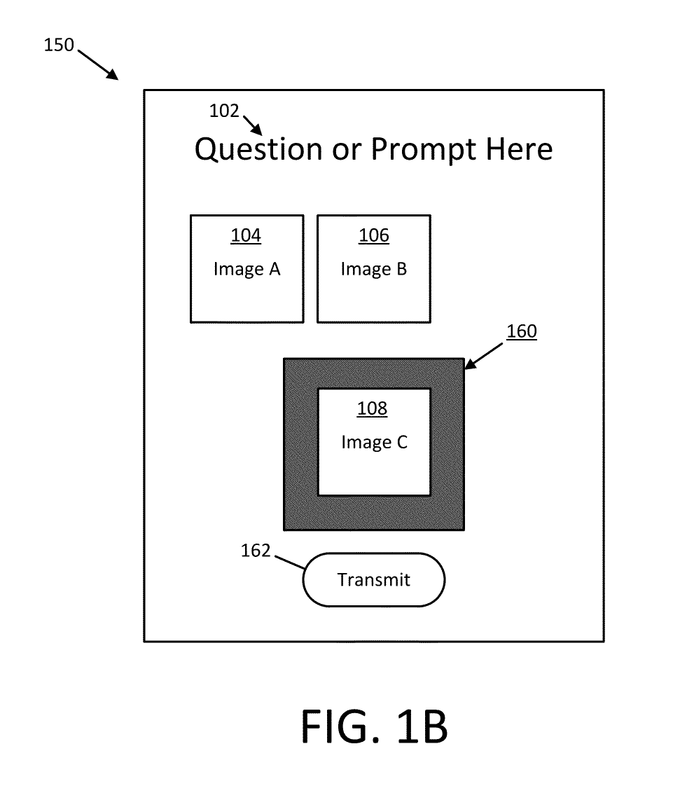

Referring to FIG. 1A, a first embodiment of an interactive display 100 is shown. Interactive display 100 includes a text prompt 102 where a question or other prompt is written to prompt the user to interact with the display 100. In the embodiment shown in FIG. 1A, three multimedia elements 104, 106, 108 are arranged on the display as image A 104, image B 106, and image C 108. A drop zone 110 and a transmit button 112 are also included. In this embodiment, interactive display 100 is a 300×250 pixel banner advertisement on a webpage. The text prompt 102 may comprise a question, request, command or other statement, preferably suggesting to the user to take some sort of action. In this embodiment, a user would select one of the images 104, 106, 108 to drag and drop onto the drop zone 110, using any input device, preferably a mouse, touchpad, or touch screen interface. This drag and drop interaction would convey the user's preference between the choices that the images 104, 106, 108 represent in response to the text prompt 102. Each image element 104, 106, 108 may have data encoded as an attribute in their HTML tags. Initially, the text of the transmit button 112 is gray to indicate to the user that it is not active yet. At this point it would not react to any clicking, touching or other user input directed at the button.

Referring now to FIG. 1B, a second view of the first embodiment of the interactive display 100 is shown. Interactive display 100 is identical to that shown in FIG. 1A except the user has already designated image C 108 by dragging and dropping it onto drop zone 110 (shown in FIG. 1A), now filled drop zone 160, which changed its background color to indicate its change in state to the user. The transmit button 112 (shown in FIG. 1A) is now enabled transmit button 162 and has also changed state and to indicate that it is active and will react to user input. In this state, if the user clicks enabled transmit button 162, a new browser window or tab would open, possibly route the user through a file on a third-party server, and then load a webpage from any third-party communication platform. The user may have to log in, sign in, provide some sort of credentials, or otherwise authenticate him or herself as a user of the communication platform. The user may also have the option of granting the interactive display 100 API access to his or her account on the communication platform. Because the user designated image C 108 by dragging and dropping it onto filled drop zone 160, any data related to image C 108, e.g., the encoded data, is transmitted to the communication platform. After authentication or if no authentication was necessary, the user would come to an interface for submitting data to the communication platform, where the transmitted data may already represent itself, preferably in one or more submission fields, but also as supplemental data to a potential submission by the user.

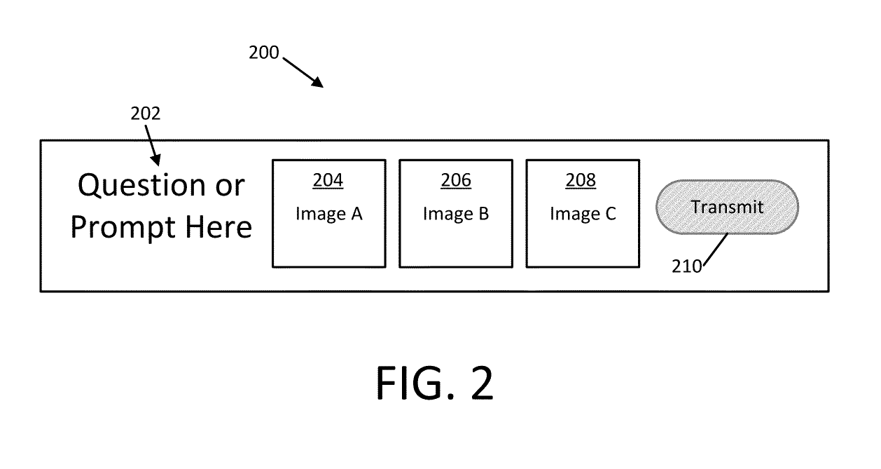

Referring now to FIG. 2, a second embodiment of an interactive display 200 is shown. Interactive display 200 may be an advertisement served while watching a video, using a mobile or non-mobile application, or as a webpage banner advertisement. This embodiment also includes a text prompt 202, multimedia 204, 206, 208 and transmit button 210, but it lacks a drop zone as shown in FIGS. 1A and 1B. A user may use an input device, preferably a mouse, touchpad or touch screen, to draw on, rearrange or select the images to designate which multimedia elements the user prefers. The transmit button 210 has gray text to indicate its inactivity, and it will change to become active when the user met the conditions of the embodiment, and clicking the active button would follow the same process as in the embodiment shown in FIGS. 1A and 1B.

The multimedia elements (e.g., multimedia elements 104, 106, 108 of FIG. 1) may be or represent any form of data, including text, images, videos, audio files, any other digital file or more complex data structures or displays comprising a plurality of data or files. The multimedia elements may take any size, shape or form, and they may be present in any number, preferably 3 to 5.

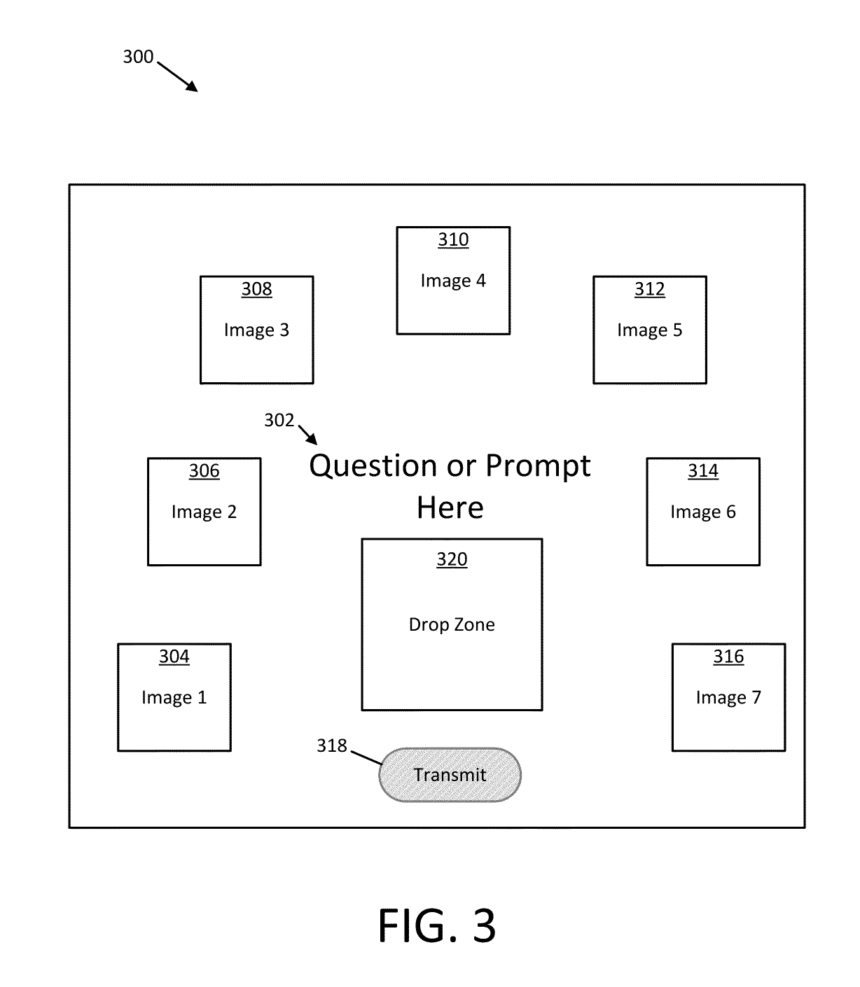

Referring now to FIG. 3, a third embodiment of an interactive display 300 is similar to the embodiment shown in FIG. 1A and 1B, but much larger and with more multimedia elements 304-316. Interactive display 300 also includes a text prompt 302 and a drop zone 320. Interactive display 300 functions in a similar way to the embodiments shown in FIGS. 1A and 1B, in that a user drags one image onto the drop zone 320 and the transmit button 318 becomes active. In some scenarios the transmit button may open a new tab in the browser rather than a new window. Alternatively, a new window may be opened.

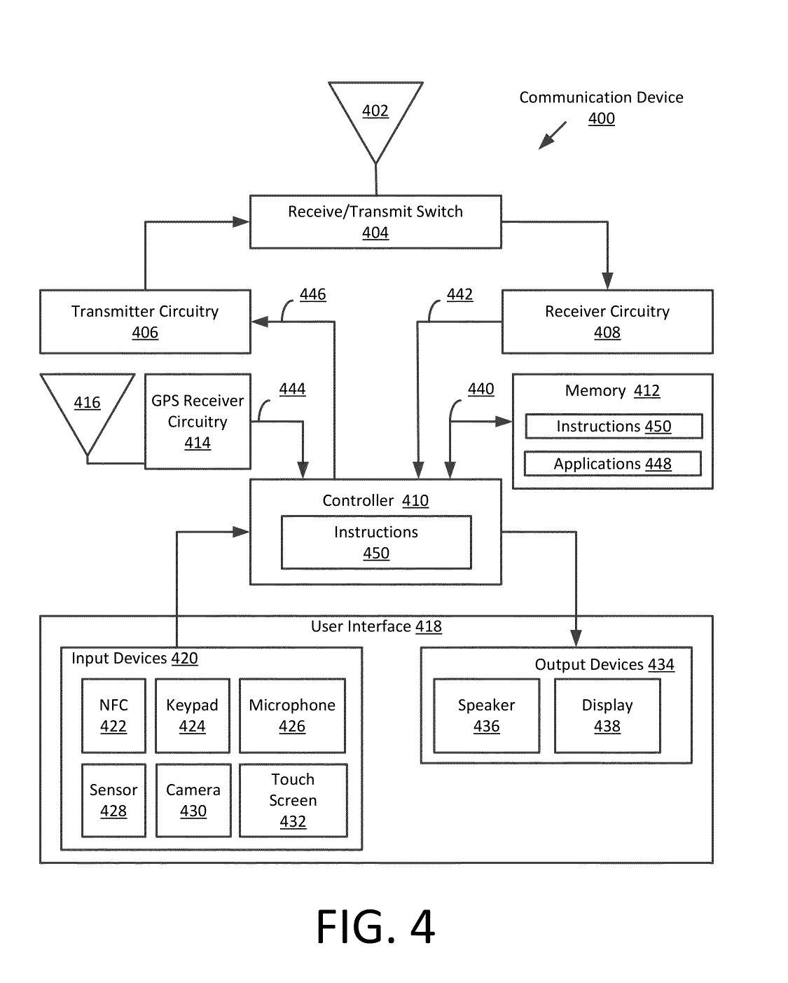

Referring now to FIG. 4, there is provided a more detailed block diagram of the communication device 400. The communication device 400 will be described herein as comprising a mobile phone or a smart phone. However, the present invention is not limited in this regard. For example, the communication device can alternatively comprise a notebook, a laptop computer, a PDA, a tablet Personal Computer (“PC”), a tablet computer, or a portable navigation device.

Notably, the communication device 400 can include more or less components than those shown in FIG. 4. For example, the communication device 400 can include a wired system interface, such as a universal serial bus interface (not shown in FIG. 4). However, the components shown are sufficient to disclose an illustrative embodiment implementing the present invention.

As shown in FIG. 4, the communication device 400 comprises an antenna 402 for receiving and transmitting Radio Frequency (RF) signals. A receive/transmit (Rx/Tx) switch 404 selectively couples the antenna 402 to the transmitter circuitry 406 and receiver circuitry 408 in a manner familiar to those skilled in the art. The receiver circuitry 408 demodulates and decodes the RF signals received from a network to derive information therefrom. The receiver circuitry 408 is coupled to a controller 410 via an electrical connection 442. The receiver circuitry 408 provides the decoded RF signal information to the controller 410. The controller 410 uses the decoded RF signal information in accordance with the function(s) of the communication device 400. The controller 410 also provides information to the transmitter circuitry 406 for encoding and modulating information into RF signals. Accordingly, the controller 410 is coupled to the transmitter circuitry 406 via an electrical connection 446. The transmitter circuitry 406 communicates the RF signals to the antenna 402 for transmission to an external device.

An antenna 416 is coupled to GPS receiver circuitry 414 for receiving GPS signals. The GPS receiver circuitry 414 demodulates and decodes the GPS signals to extract GPS location information therefrom. The GPS location information indicates the location of the communication device 400. The GPS receiver circuitry 414 provides the decoded GPS location information to the controller 410. As such, the GPS receiver circuitry 414 is coupled to the controller 410 via an electrical connection 444.

The controller 410 stores information in a memory 412 of the communication device 400. Accordingly, the memory 412 is connected to and accessible by the controller 410 through an electrical connection 440. The memory 412 can be a volatile memory and/or a non-volatile memory. For example, the memory 412 can include, but is not limited to, a Random Access Memory (RAM), a Dynamic Random Access Memory (DRAM), a Static Random Access Memory (SRAM), Read-Only Memory (ROM) and flash memory. The memory 412 can also have stored therein the software applications 448 and instructions 450.

The software applications 448 include, but are not limited to, applications operative to provide telephone services, network communication services, GPS based services, navigation services, location services, position reporting services, traffic status services, tour information services, commerce services, email services, web based services, and/or electronic calendar services.

As shown in FIG. 4, one or more sets of instructions 450 are stored in the memory 412. The instructions 450 can also reside, completely or at least partially, within the controller 410 during execution thereof by the communication device 400. In this regard, the memory 412 and the controller 410 can constitute machine-readable media. The term “machine-readable media”, as used here, refers to a single medium or multiple media that store the one or more sets of instructions 450. The term “machine-readable media”, as used here, also refers to any medium that is capable of storing, encoding or carrying the set of instructions 450 for execution by the communication device 400 and that cause the communication device 400 to perform one or more of the methodologies of the present disclosure.

The controller 410 is also connected to a user interface 418. The user interface 418 is comprised of input devices 420, output devices 434, and software routines (not shown in FIG. 4) configured to allow a user to interact with and control software applications 448 installed on the computing device 400. Such input and output devices respectively include, but are not limited to, a display 438, a speaker 436, a keypad 424, a directional pad (not shown in FIG. 4), a directional knob (not shown in FIG. 4), a microphone 426, sensors 428, a camera 430, and a touch screen 432.

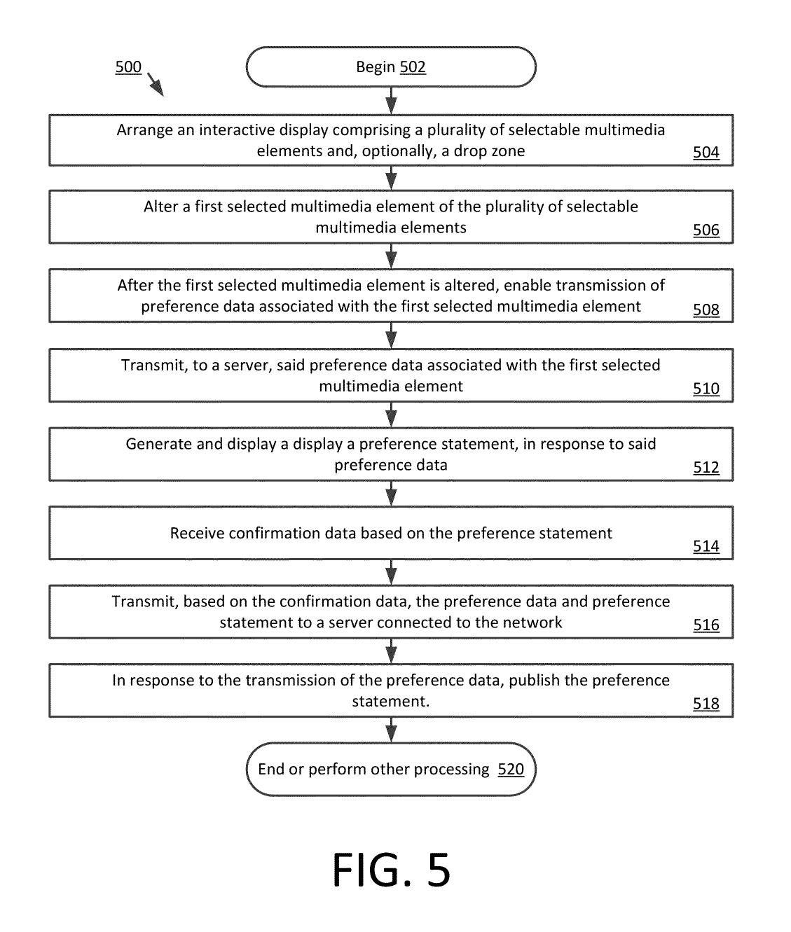

Referring now to FIG. 5, a process 500 is shown. Process 500 begins at step 502 and continues to step 504 where an interactive display is arranged comprising a plurality of selectable multimedia elements and, optionally, a drop zone. The interactive display may also include a text prompt that encourages the user to participate in a poll or to answer a question concerning the user's preferences. In an example, the plurality of selectable multimedia elements may be images that represent a preference for a product or brand. The user is asked which of the displayed products they prefer. In other examples, the user may be asked to select a favorite reality show contestant. The embodiments of the present invention are not limited in this regard.

To designate a preference, the user must alter a selected multimedia element in some way in step 506. In a preferred embodiment, the user may select the multimedia element, drag the multimedia element to the drop zone, and drop the multimedia element in the drop zone. In other embodiments, the user may select the multimedia element to alter the elements color, rearrange the elements present on the interactive display, draw on and/or with the elements on the display, and the like. Alternatively, the user may designate the selected multimedia element by performing a gesture on a touch screen device. The embodiments are not limited in this regard.

Once a multimedia element is selected and/or altered, the transmission of preference data associated with the selected multimedia element is enabled in step 508. In an example, the interactive display may include a transmit button that is initially disabled, or “grayed out.” Once the multimedia element is selected and/or altered, the transmit button becomes enabled or active. The user may activate the transmit button to transmit preference data associated with the selected multimedia element to a server hosting a communication platform in step 510. Alternatively, the transmission may occur automatically based on the passage of a predetermined amount of time. In such a case, the preference data that is transmitted may be of the multimedia element that was in the drop zone as time expired.

After the preference data is transmitted to the server, a preference statement is generated by the server and displayed to the user in step 512, in response to the preference data. The preference statement may be in the form of an automatically generated social network post that expresses an opinion on a reality show contestant or on a favorite product or brand. After the preference statement is displayed, the user may choose whether to post the preference statement on his/her social networking platform. When the user elects to post the preference statement, the system receives confirmation data indicating that the user authorizes the preference statement to be posted on the social networking platform in step 514. Based on the confirmation data, the preference data and/or statement is transmitted to the social networking server in step 516. The social networking server publishes the preference statement on the user's social networking platform, hosted by the server in step 518. In step 520, process 500 ends or other processing is performed.

The system may provide a process or mechanism by which a user may designate one or more, preferably 1 to 3, of the multimedia elements. The system may end the user designation phase based on a time, user input, and/or lack thereof. At the end of the user designation, the invention will discern which of the multimedia elements the user designated and which the user did not.

The system may process information about the state of any number of its components, especially the multimedia elements. Data may be encoded directly into any part of the display and accessed by the system, including the multimedia elements and hidden elements. The system may also access any information available to itself from other parts of the digital display, the hosting system, the user client, and/or any other entity. The data may be used by the system to access any number of local or remote entities, including servers, file systems, documents, media, databases and third-party APIs, and retrieve any amount of data from any of the local or remote entities. The system may use any amount of this data with any algorithms, statistics or other data to produce a data package comprising any amount of data.

For example, the use of preference analytics requires a user's interactions to be tracked. Data concerning changes to a user's interactions, opinions, and choices must be updated regularly.

The system may use any combination of any methods of transmission, including SMTP, HTTP, FTP, and/or any API for any system, to send the data package. The system may send the data package directly to a third party, or it may send it to any number of any intermediaries before the last intermediary sends the data package to the third party. The third party may be any digital entity connected to any part of a communication platform (any digital structure that allows entities to interact with it, each other or both, including websites, web frameworks, applications on mobile and non-mobile devices, servers, et cetera).

Applications of the system may include advertisement campaigns, social media campaigns, marketing campaigns, public relations campaigns or any other effort to deliver any information to any number of people or groups of people. The system may also be used for any type of crowd-sourced data processing or collection, including polling, mathematical problems, pattern matching, data association, situational decisions or any other task that the invention can convey through its medium.

The foregoing examples and description of the preferred embodiments should be taken as illustrating, rather than as limiting the present invention as defined by the claims. As will be readily appreciated, numerous variations and combinations of the features set forth above can be utilized without departing from the present invention as set forth in the claims. Such variations are not regarded as a departure from the spirit and script of the invention, and all such variations are intended to be included within the scope of the following claims.

We claim:

1. A system for online advertisements that encourages users to express purchase preference or brand interest on their social media networks through rich media interactions, the system comprising:
a processor;
a network interface configured to connect to a network; and
a machine readable storage medium configured to store program instructions which, when executed, cause the processor to:
arrange, on a display, an interactive display comprising a prompt and a plurality of selectable multimedia elements;
receive, from a user, a first information indicating the designation of a first selected multimedia element of the plurality of selectable multimedia elements;
after said first selected multimedia element is altered, enable transmission of preference data associated with said first selected multimedia element; and
transmit, by the network interface, said preference data associated with said first selected multimedia element designated by said user to a server connected to the network, wherein said preference data is responsive to the prompt.

2. The system according to claim 1, wherein the instructions further cause the processor to display a preference statement is generated by the server, in response to said preference data.

3. The system according to claim 2, wherein the instructions further cause the processor to:
receive a second information indicating authorization for the preference statement to be published; and
publish the preference statement as a prompt on a social network feed associated with said user.

4. The system according to claim 3, wherein the preference statement encourages other social network users associated with said user to respond to the prompt using the interactive display.

5. The system according to claim 4, wherein the first information corresponds to an indication that the selected multimedia element has been rearranged.

6. The system according to claim 5, wherein the interactive display further comprises a drop zone and the first selected multimedia element is designated dragging and dropping the multimedia element into the drop zone.

7. The system according to claim 6, wherein the instructions further cause the processor to remove the first selected multimedia element from the drop zone on a condition that a second selected multimedia element is dragged and dropped into the drop zone.

8. The system according to claim 7, wherein the instructions further cause the processor to transmit preference data associated with one of the plurality of multimedia elements that is in the drop zone at the end of a predetermined length of time.

9. A method for encouraging users to express purchase preference or brand interest on their social media networks through rich media interactions, the method comprising:
arranging an interactive display comprising a prompt and a plurality of selectable multimedia elements;
receiving, from a user, a first information indicating the designation of a first selected multimedia element of the plurality of selectable multimedia elements;
after said first selected multimedia element is altered, enabling transmission of preference data associated with said first selected multimedia element; and
transmitting, by the network interface, said preference data associated with said first selected multimedia element designated by said user to a server connected to the network, wherein said preference data is responsive to the prompt.

10. The method according to claim 9 further comprising displaying a preference statement is generated by the server, in response to said preference data.

11. The method according to claim 10 further comprising:
receiving a second information indicating authorization for the preference statement to be published; and
publishing the preference statement as a prompt on a social network feed associated with said user.

12. The method according to claim 11, wherein the preference statement encourages other social network users associated with said user to respond to the prompt using the interactive display.

13. The method according to claim 12, wherein the first information corresponds to an indication that the selected multimedia element has been rearranged.

14. The method according to claim 13, wherein the interactive display further comprises a drop zone and the first selected multimedia element is designated dragging and dropping the multimedia element into the drop zone.

15. The method according to claim 14 further comprising removing the first selected multimedia element from the drop zone on a condition that a second selected multimedia element is dragged and dropped into the drop zone.

16. The method according to claim 15 further comprising transmitting preference data associated with one of the plurality of multimedia elements that is in the drop zone at the end of a predetermined length of time.
